(19) United States
(12) Patent Application Publication
(10) Pub. No.: US 2019/0227813 A1
(43) Pub. Date: Jul. 25, 2019

(54) SYSTEM, METHOD, AND NON-TRANSITORY COMPUTER-READABLE STORAGE MEDIA FOR GENERATING DATA FOR USE IN COMPUTER SYSTEMS

(71) Applicant: VIRTUAL ADVANTAGE L.L.C., Troy, MI (US)

(72) Inventor: Nicholas Ashton Daniels, Macomb, MI (US)

(21) Appl. No.: 16/051,148

(22) Filed: Jul. 31, 2018

Related U.S. Application Data
(60) Provisional application No. 62/538,935, filed on Jul. 31, 2017.

(51) Int. Cl. G06F 9/445; G06F 8/61; G06F 8/70

(52) U.S. Cl. CPC G06F 9/4451; G06F 8/70; G06F 8/61

(57) ABSTRACT

A networked computer system is described herein. The networked computer system includes a mobile computing device and a mobile application server in communication with the mobile computing device. The mobile application server computer includes a processor programmed to display a company culture selection webpage on the mobile computing device including one or more user selectable company culture indicators. The mobile application server then receives a user selection of a company culture indicator and displays an activity capture screen that allows the user to operate a camera of the mobile computing device to capture a digital photo image of an event, select an employee ID associated with one or more employees included in the photo image, and input a textual description of the captured activity.

### CROSS-REFERENCE TO RELATED APPLICATION

This application claims benefit of U.S. Provisional Application Ser. No. 62/538,935, filed Jul. 31, 2017, the disclosure of which is hereby incorporated by reference in its entirety for all purposes.

### FIELD OF THE DISCLOSURE

The present invention relates to networked computer systems, and more particularly, to a networked computer system including mobile devices for capturing image data and attaching additional information to the image data for use in generating data associated with behaviors depicted in the capture images.

### BACKGROUND OF THE INVENTION

At least some known mobile computing devices include cameras capable of capturing video image data and mobile computer applications that allow users to operate these cameras to capture images and transmit digital images to remote storage devices. At least some known applications attach additional information to the image files including date and time at which the image was taken.

However, in at least some known mobile application, the information included with the digital image file is limited. As such, extracting additional information from the image file such as, for example, the location of the image and/or the objects or activity captured by the image becomes cumbersome and requires additional computing resources, thus reducing the overall performance of these systems.

The present invention is aimed at one or more of the problems identified above.

### SUMMARY OF THE INVENTION

In one embodiment of the present invention, a networked computer system is provided. The networked computer system includes a mobile computing device and a mobile application server in communication with the mobile computing device. The mobile computing device includes a mobile computing device processor, a memory device, a touchscreen, and a camera. The memory device having an activity-capture software application program stored therein that, when executed, causes the mobile computing device processor to display a graphical user interface via the touchscreen. The mobile application server computer includes a processor programed to receive a request to initiate an activity-capture sequence from a user via the mobile computing device including a signal from the mobile computing device indicating an initiation of the activity-capture software application program by the user, and transmit instructions to the mobile computing device to cause the mobile computing device to display an activity capture webpage prompting the user to enter a user identifier. Upon receiving the user identifier, the mobile application server displays a company culture selection webpage on the mobile computing device including one or more user selectable company culture indicators. The mobile application server then receives a user selection of a company culture indicator and displays an activity capture screen that allows the user to operate the camera of the mobile computing device to capture a digital photo image of an event, select an employee ID associated with one or more employees included in the photo image, and input a textual description of the captured activity. The mobile application server receives the captured information from the mobile computing device, generates an activity-capture data record including the information received from the mobile computing device, and stores the activity-capture data record in a database. The mobile application server is also programmed to receive a request from a user computing device to generate a culture activity report including an employee ID, access the database to retrieve one or more activity-capture data records having a matching employee ID, and analyze the retrieved activity-capture data records to generate various culture action reports. The mobile application server then generates and displays a reporting webpage on the user computing device to display the various culture action reports via the reporting webpage.

In another embodiment of the present invention, one or more non-transitory computer-readable storage media, having computer-executable instructions embodied thereon are provided. When executed by a processor, the computer-executable instructions cause the processor to receive a request to initiate an activity-capture sequence from a user via a mobile computing device including a signal from the mobile computing device indicating an initiation of the activity-capture software application program by the user, and transmit instructions to the mobile computing device to cause the mobile computing device to display an activity capture webpage prompting the user to enter a user identifier. Upon receiving the user identifier, the processor displays a company culture selection webpage on the mobile computing device including one or more user selectable company culture indicators. The processor then receives a user selection of a company culture indicator and displays an activity capture screen that allows the user to operate a camera of the mobile computing device to capture a digital photo image of an event, select an employee ID associated with one or more employees included in the photo image, and input a textual description of the captured activity. The processor receives the captured information from the mobile computing device, generates an activity-capture data record including the information received from the mobile computing device, and stores the activity-capture data record in a database. The processor also receives a request from a user computing device to generate a culture activity report including an employee ID, accesses the database to retrieve one or more activity-capture data records having a matching employee ID, and analyzes the retrieved activity-capture data records to generate various culture action reports. The processor then generates and displays a reporting webpage on the user computing device to display the various culture action reports via the reporting webpage.

### BRIEF DESCRIPTION OF THE DRAWINGS

FIG. 1 is schematic view of a system for use in generating estimated property affordability prices, according to an embodiment of the invention;

FIG. 2 is another schematic view of a system for use in generating estimated property affordability prices, according to an embodiment of the invention;

FIG. 3 is a schematic illustrating an exemplary user computing device that may be used with the system shown in FIG. 1, according to an embodiment of the present invention;

FIG. 4 is a schematic illustrating example components of a server computer that may be used with the system shown in FIG. 1, according to an embodiment of the present invention;

FIG. 5 is a flowchart of a method that may be used with the system shown in FIG. 1, according to embodiments of the present invention;

FIG. 6 is a flowchart of a method that may be used with the system shown in FIG. 1, according to embodiments of the present invention;

FIGS. 7 and 8 are illustrations of exemplary data files generated by the system shown in FIG. 1, according to embodiments of the present invention; and

FIGS. 9-41 are illustrations of exemplary screenshots from the system of FIG. 1, according to an embodiment of the present invention.

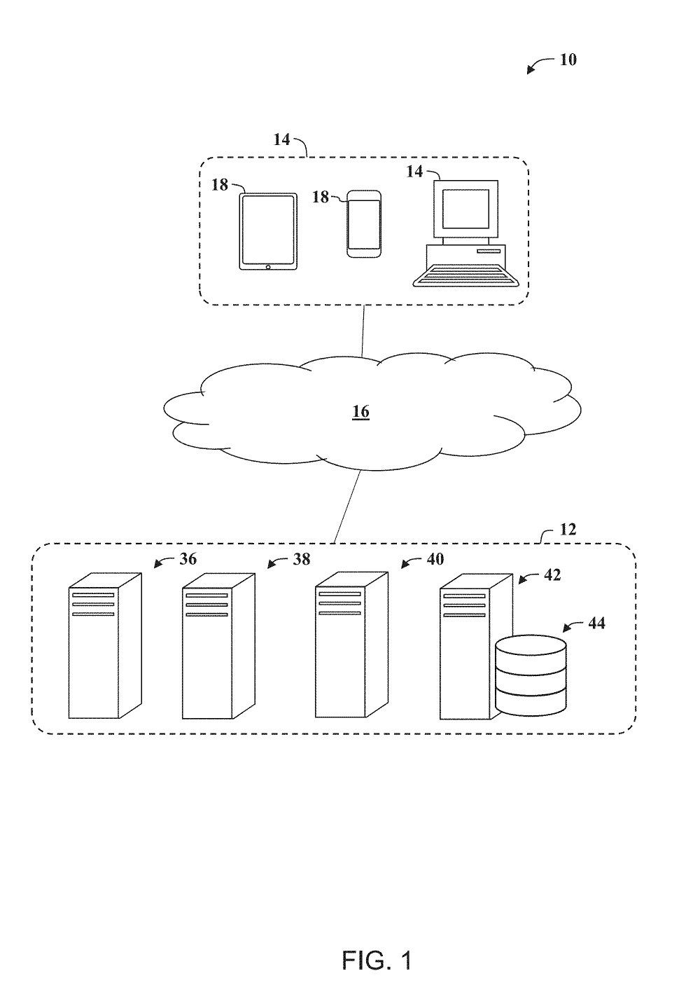

Corresponding reference characters indicate corresponding components throughout the several views of the drawings.

### DESCRIPTION OF THE PREFERRED EMBODIMENT(S)

With reference to the drawings, and in operation, the present invention overcomes at least some of the disadvantages of known systems by providing a disruptive culture innovation platform to cultivate an ecosystem of empowerment by celebrating desired culture behavior—culture engagement, gamification, evangelism, manifestation.

In general, the Kultūra® system includes a computer server system 10 that provides each employee with an empowerment tool that allows them to capture actions and activity of catching people doing good. The application features the following: Building sharing loops—social network & sharing, tagging (anonymous or not), achievements; Simple reporting process—maintain ease-of-use, minimal effort for end-user to capture positive behavior; Push notification objectives—retention levels, increased engagement, build a viral loop, push strategic objectives through the application; Ingrained with the ecosystem—seamless culture/branding experience, fits existing organization culture and helps define/refine core values & pillars; Instant gratification & value add—user feels accomplished, special, outdone. Learned something valuable; Quick rewards system—smaller milestone achievements, longer engagement with the application, frequency of rewards.

The Kultūra® system 10 creates a higher level of company advocacy & evangelism, which yields the following: Long-time employee retention; Personal employee growth; Employee-to-business interaction growth; Compete to compare; Organizational gamification; Brand validation, brand engagement, rerecruiting & employee ambassadorship.

In general, the Kultūra® system 10 is made available to users through Android play store, and Apple app store. As a white labeled solution, the application is available through a cloud hosted download site for convenience factor—deployment, distribution, and implementation can be escalated through the DL site. Once user has navigated to the application DL site from either Android or Apple device, he or she must prompt the download by selecting the application type, specific to the device they are using—i.e. Apple application download, or Android application download. After the selection has been made, the DL site requires a layer of authentication to verify credentials provided by the organization—i.e. username and password. The application will then install directly to the root “Home Screen” (Android), or the “Springboard” of the device. The user must then navigate to the phones General Settings, Profiles & Device Management, and, “Trust,” the apps distributed from the organizations developer account. Once these steps are completed, the application is now properly installed on the users' device, and ready for user setup.

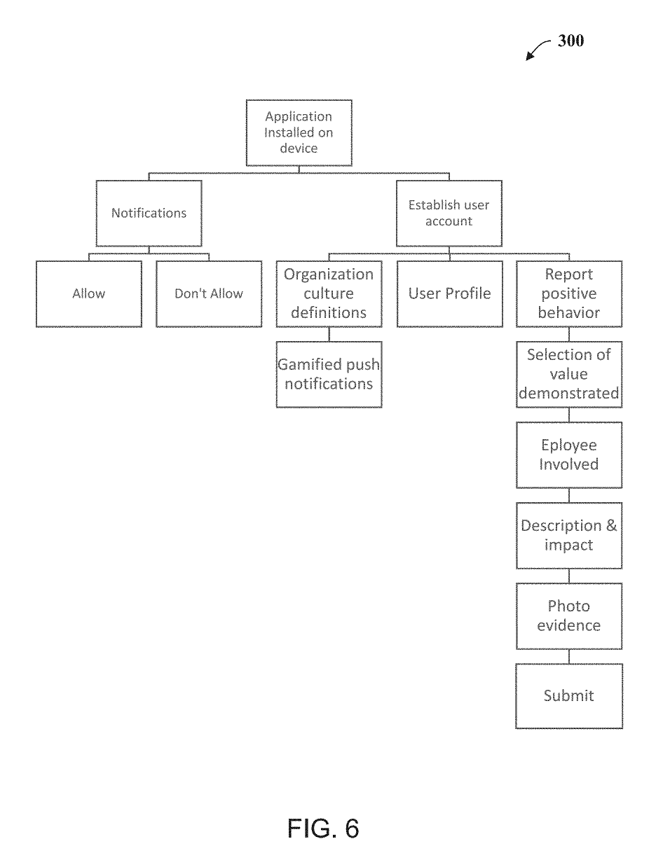

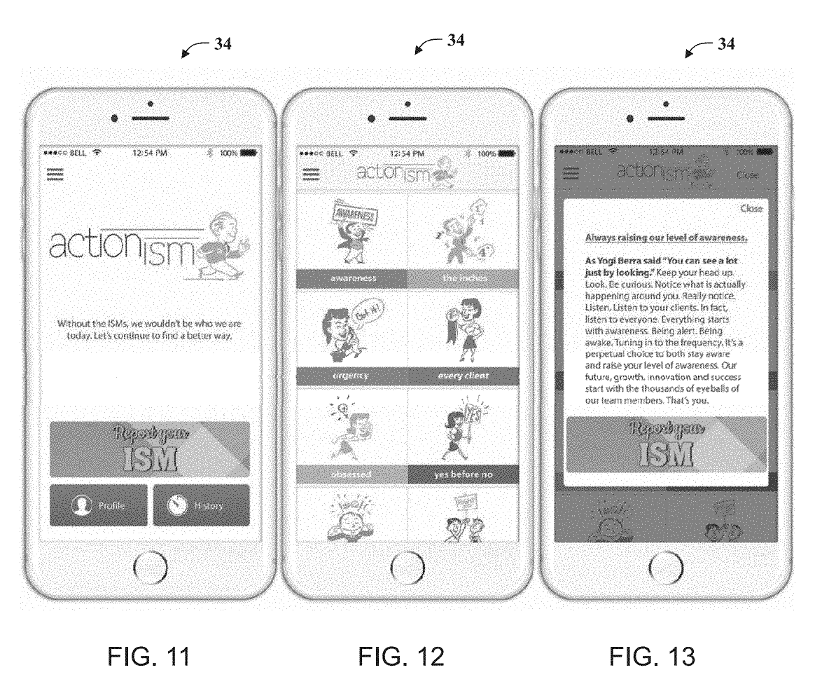

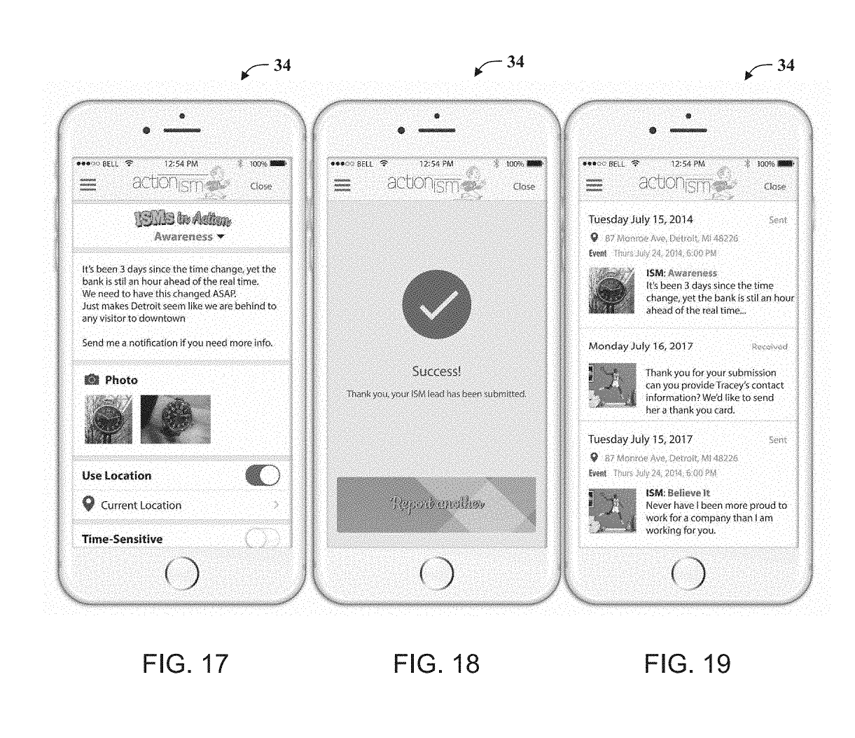

Application Workflow Description: “Sender”: Referring to FIGS. 6 and 9-19, upon opening the application, Kultūra® requires each user to establish an email address for reference; furthermore; the application notifies the user of push notifications—the user may allow or decline the offer. The application will then bring the user to the profile screen, where the user will then define the requested profile parameters defined by the organization deploying the application. These profile parameters assist in defining future talent pools, and rerecruiting efforts. The organization the application is purposed for, will have an area for defined culture values and pillars to live—this area is to serve as a knowledgebase. The knowledgebase allows for the applications user to educate him or herself on the organizations stance on their value propositions—provide definitions and expressive examples. The user will report a positive human behavior in direct relation to one of the organizations value propositions, core values, principles, and/or pillars defined in the knowledgebase. The user is required to select the core value being surveyed, tag the employee(s) involved in the act, write a brief description, and impact the action has, capture the moment with a photo or multiple photos, and define the location. The user will then submit this act of good directly through the application by hitting submit. This information is then housed directly into a database called, Scout. After this submission is imported, the sender's act of capturing someone doing good will notify the receiver of the value he or she was capture in. The send has the option of remaining anonymous, or presenting his or her name to the receiver through means of a push notification through the application.

“Receiver” The receiver will collect a notification directly from the Kultūra® application. Each notification defines the core value being presented, and a clause that can be purposed in any manor—again, defined by the organization. The receiver can click into the notification, which will navigate the receiver directly to the core value that he or she was captured expressing, or involved in. The process is to further validate, and educate each user of the organizations core values, cultures, principles, or pillars defined in the application.

The system 10 includes a computer application software for mobile phones, portable media players, computers, handheld computers and other peripherals with internet capability, namely, software for employees of an organization or entity to capture, tag other employees, record the act through video or photo, provide brief summary on act, note physical geo location, and submit from mobile device into back-end database for the purpose of acknowledging Positive acts of fellow employees consistent and or in furtherance of an entities culture or core values.

The system 10 also includes software applications and programs used to detect, record, authenticate, endorse, communicate, alert, document, notify, tag, and catch instances of genuine, authentic, human behavior to validate an organizations culture, strategy, pillars, and ethics-getting caught doing good, and celebrating desired behaviors.

Objective: Cultivate an Ecosystem that empowers its people by celebrating desired culture behavior. The system 10 enables user to create an environment that allows for people to become more engaged with an organizations culture, including: Self-Propagating, self-preserved, self-healing; Culture value recognition (culture value vs. core value); “You were caught doing good”; Systematically designing and celebrating culture engagement, Culture is the number 1 indicator of innovation, growth, validation, and brand reinforcement.

Culture can be defined as an unmeasurable phenomenon; however, once paired with a process that allows an organization to collect data based off employee behavior and evolve that data into actionable intelligence—culture can now be defined as a brand validation tool that allows an organization to disrupt the culture status quo.

How: By empowering each employee with a tool that allows them to capture behavior and activity of doing good.

Why: To create a higher level of company advocacy and evangelism, which yields the following: Long-term employee retention; Personal employee growth; Advancement in employee-to-Business interaction; Persistently different environment; Compete to compare mentality.

| | |
|---|---|
| Set Objectives: retention | Add Value: user should feel accomplished, |
| levels, increased engagement, | special, outdone. Learned something really |
| build a viral loop. | awesome. |
| Ingrained with the ecosystem: | Keep it Simple: maintain ease-of-use, |
| seamless experience, fits | minimal effort for end-user to capture |
| existing organization culture. | behavior |
| Build Sharing Loops: social | Quick Rewards: smaller milestone |
| network & sharing, tagging, | achievements, longer engagement with the |
| achievements. | application, frequency of rewards |

How do we analyze culture? Observation/Instruction. Imitation. Reinforcement. Internalization. Spontaneous Manifestation.

In the illustrated embodiment, the system 10 includes a server system 12 that is coupled in communication with one or more user computing devices 14 via a communications network 16. The communications network 16 may be any suitable connection, including the Internet, file transfer protocol (FTP), an Intranet, LAN, a virtual private network (VPN), cellular networks, etc. . . . , and may utilize any suitable or combination of technologies including, but not limited to wired and wireless connections, always on connections, connections made periodically, and connections made as needed.

The user computing device 14 may include any suitable device that enables a user to access and communicate with the system 10 including sending and/or receiving information to and from the system 10 and displaying information received from the system 10 to a user. For example, in one embodiment, the user computing device 14 may include, but is not limited to, a desktop computer, a laptop or notebook computer, a tablet computer, smartphone/tablet computer hybrid, a personal data assistant, a handheld mobile device including a cellular telephone, and the like. The user computing device 14, as well as any other connected computer systems and their components included in the system 10, can create message related data and exchange message related data (e.g., near field communication (“NFC”) payloads, Bluetooth packets, Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

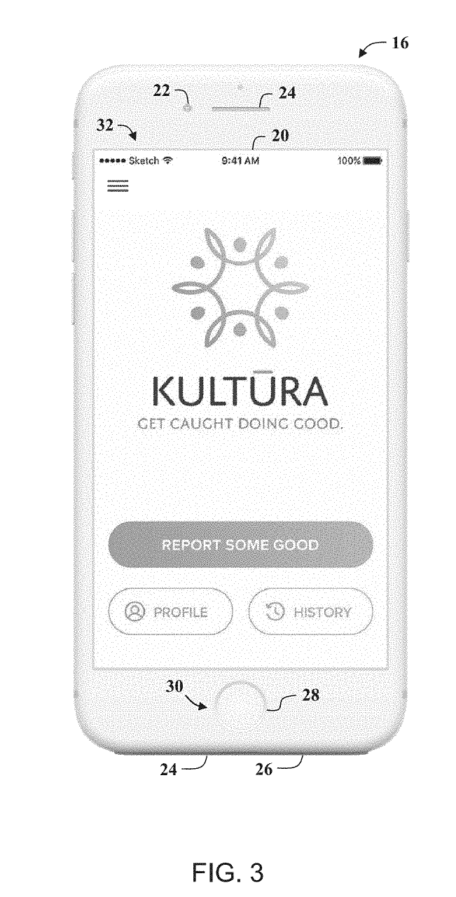

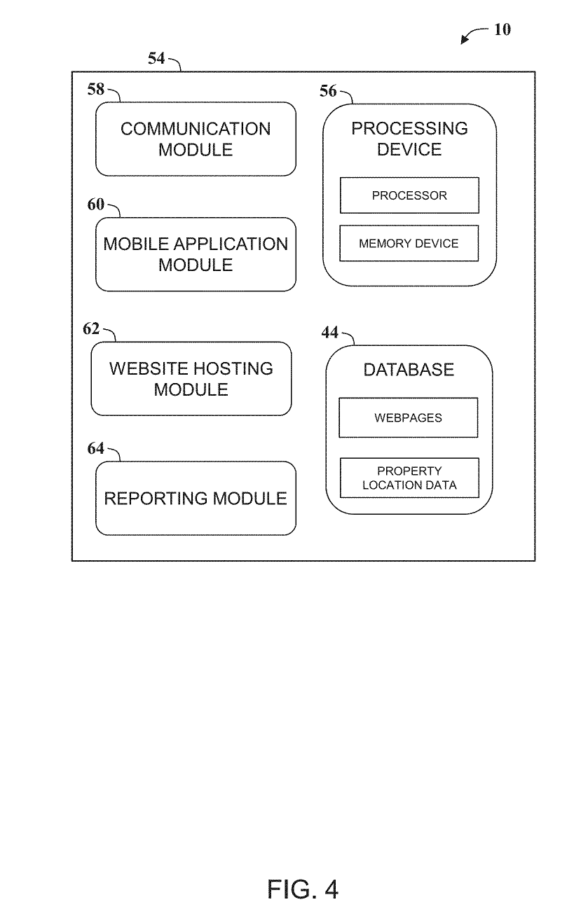

In one embodiment, the user computing device includes a mobile computing device 18 (shown in FIG. 3) such as, for example, a smartphone such as an iPhone™. The mobile computing device 18 includes a processor coupled to a memory device, and a database for storing various programs and data for use in operating the mobile computing device 18. The mobile computing device 18 may also include a touchscreen display device 20, one or more video image cameras 22, one or more speakers 24, a microphone 26, at least one input button 28, and one or more sensors 30 including, but not limited to, a touch ID fingerprint sensor coupled to an input button 28, a barometer, a three-axis gyro, an accelerometer, proximity sensor, and an ambient light sensor. In addition, the mobile computing device 18 may also include a Wi-Fi antenna, a cellular network antenna, a Bluetooth™ communications device, assisted Global Positioning System (GPS) and a Global Navigation Satellite System (GLONASS), a digital compass, and/or an iBeacon™ microlocation device.

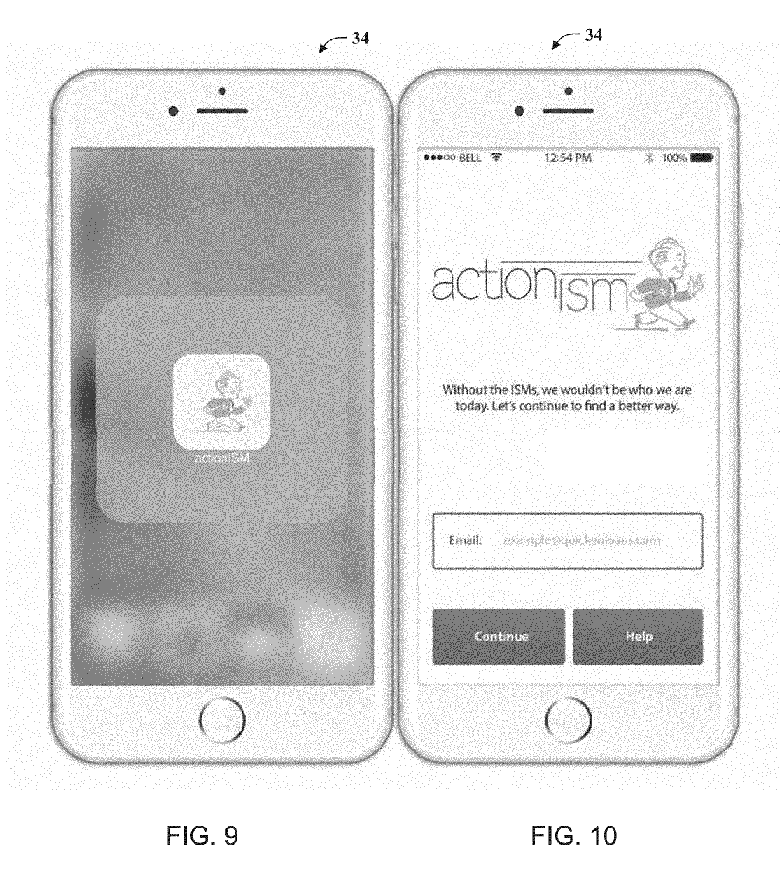

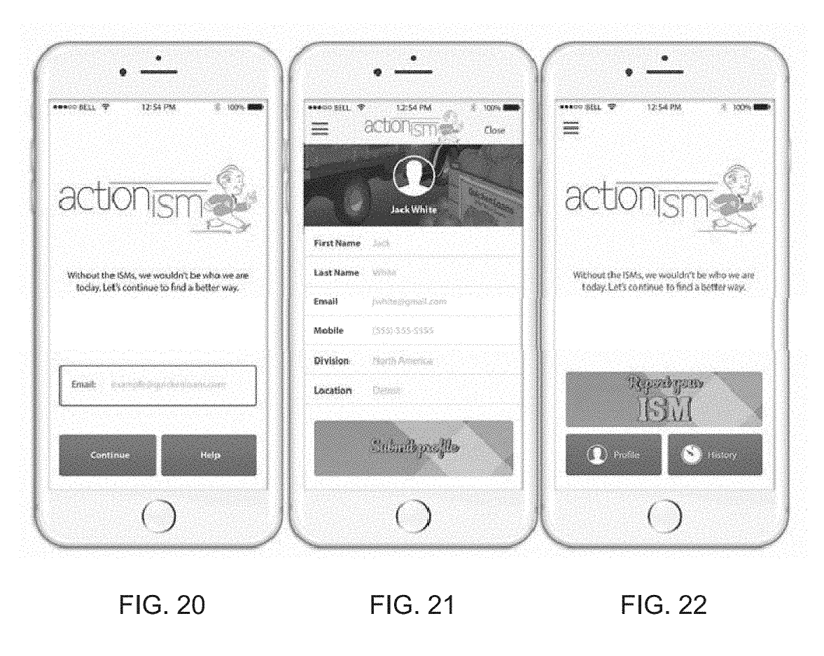

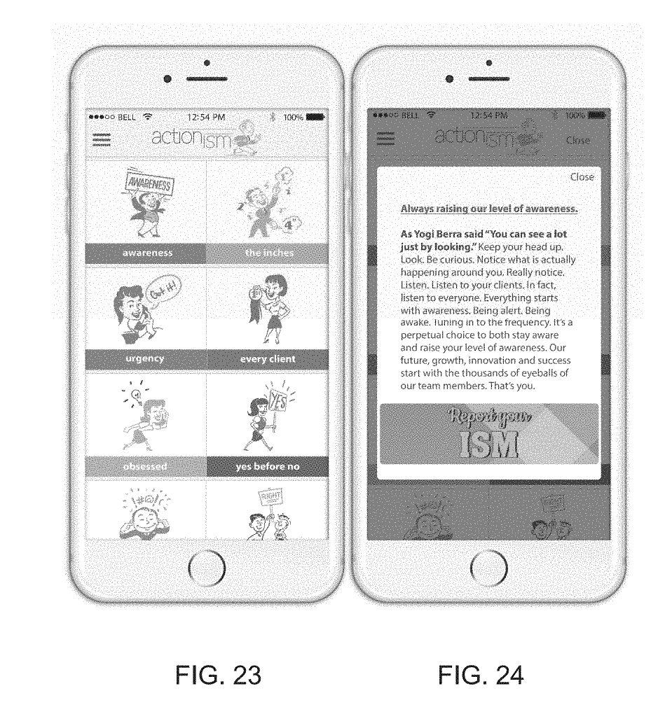

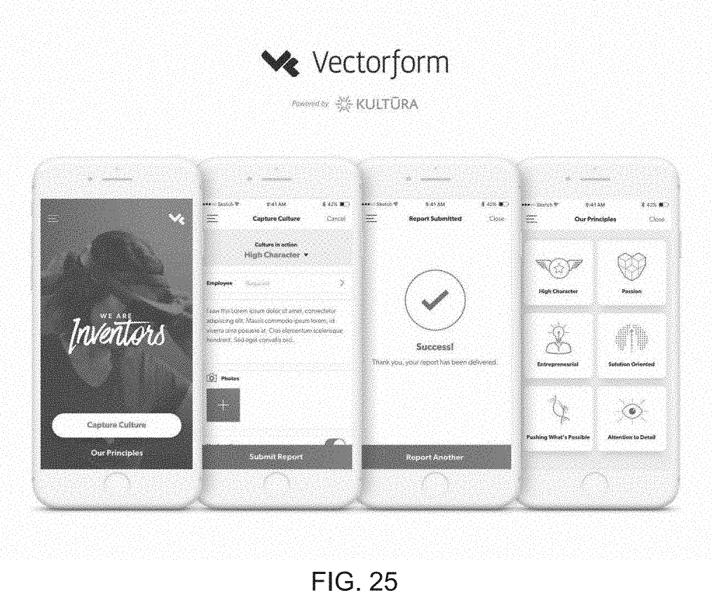

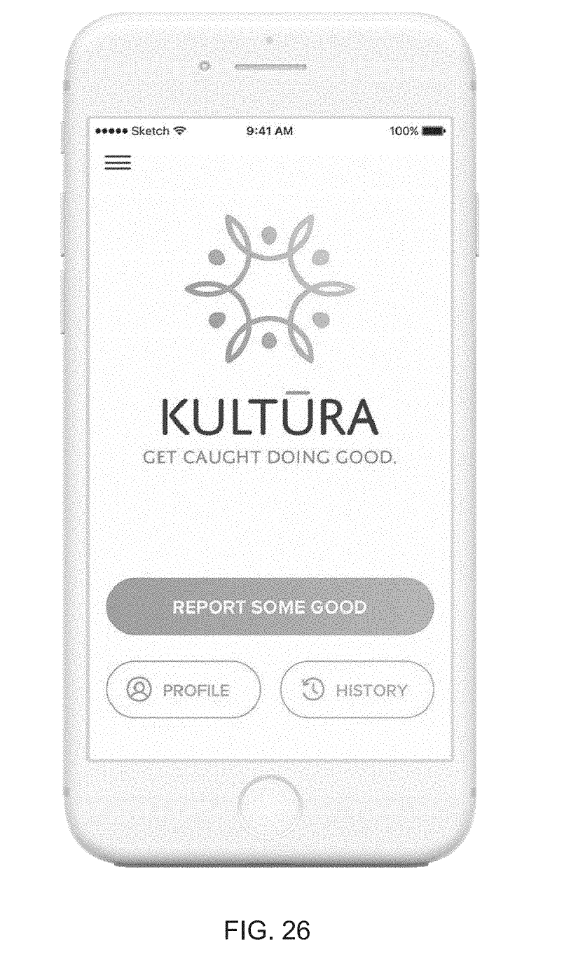

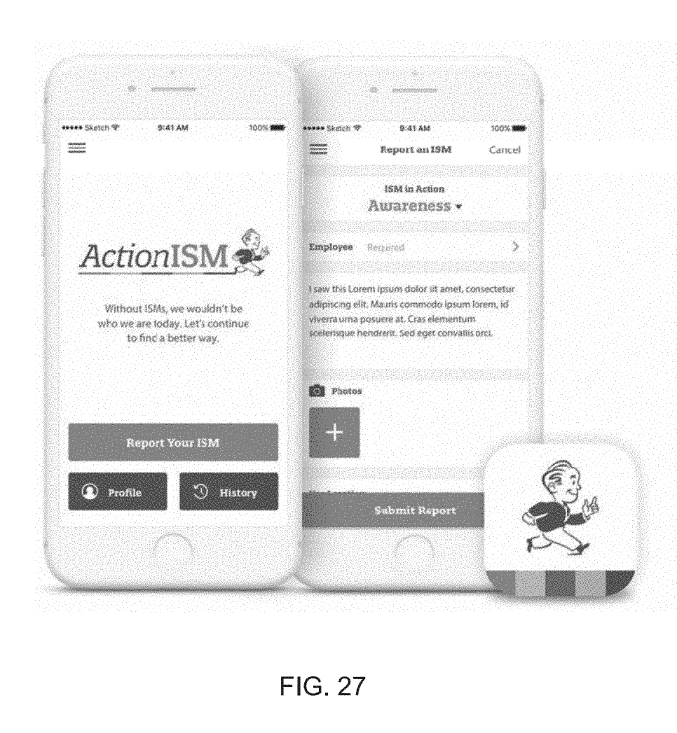

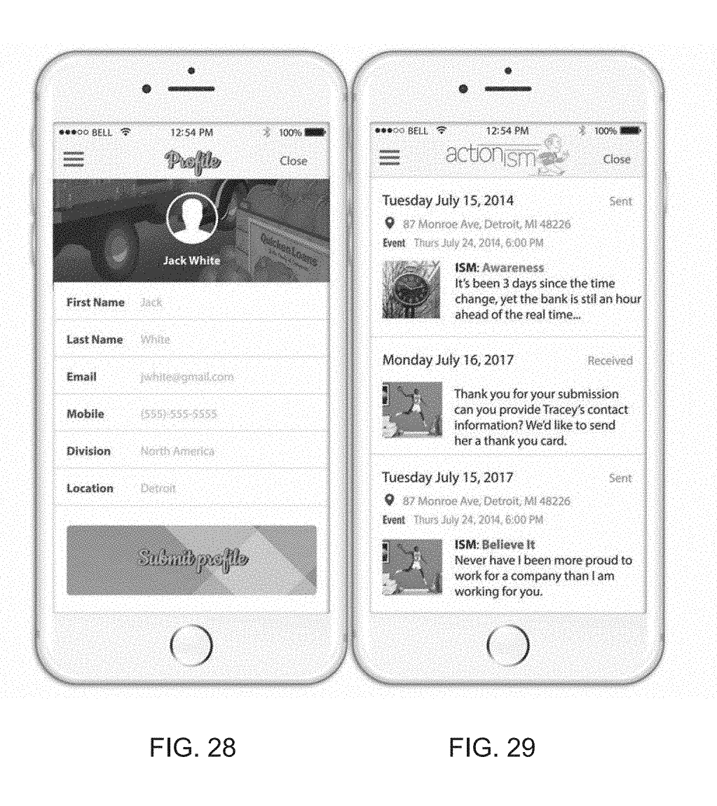

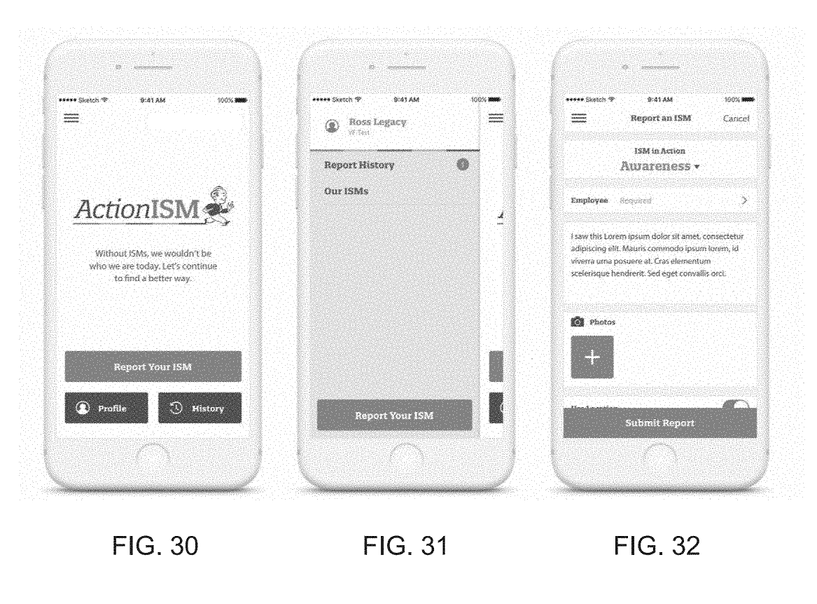

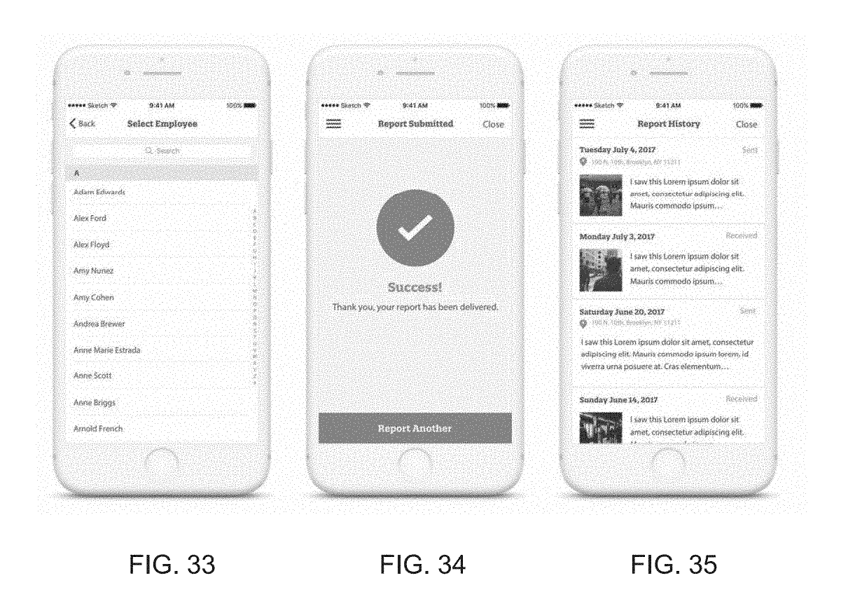

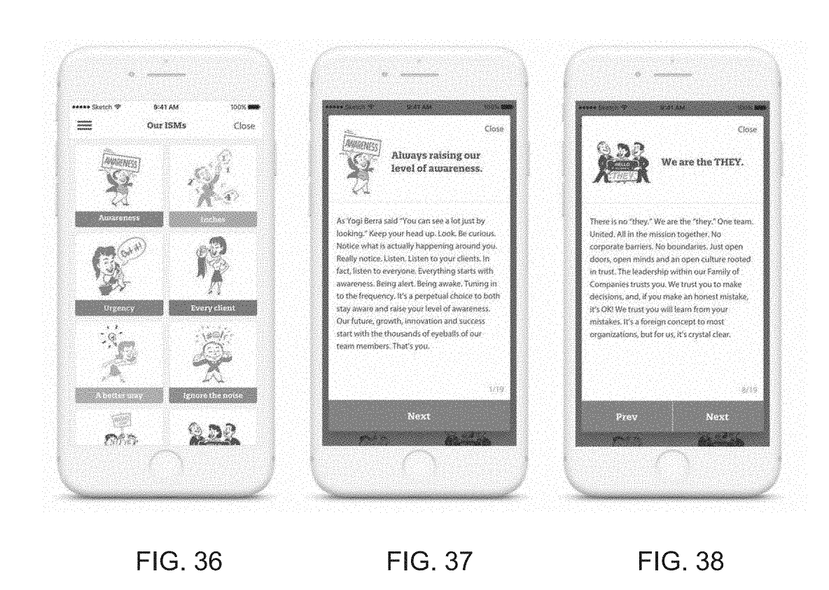

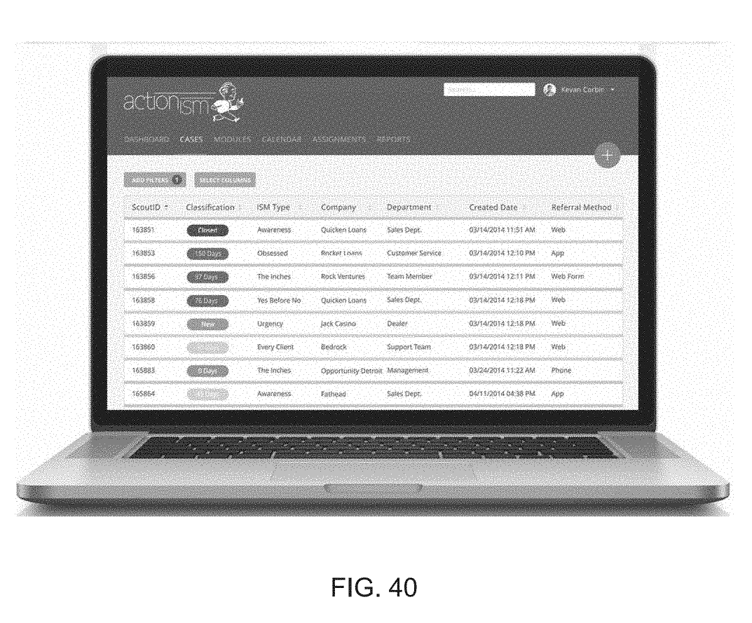

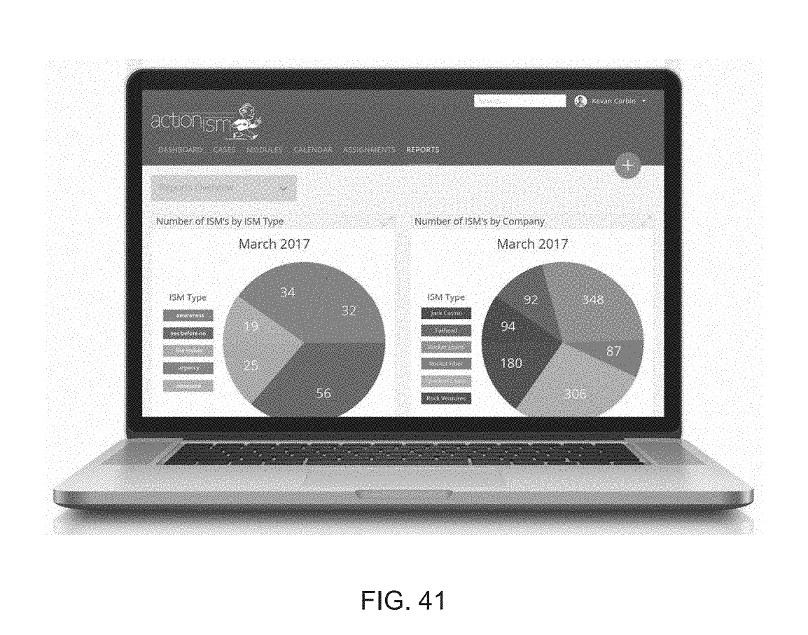

In the illustrated embodiment, the mobile computing device 18 includes one or more software application programs that are stored in the memory device. The processor executes the application program to display a graphic user interface 32 on the touchscreen display device 20 that includes information received from the server system 12 to enable a user to interact with and operate the server system 12. In addition, the mobile computing device 18 may be programmed to store and execute a computer program applications that display user interfaces 32 (shown in FIGS. 9-41) on the touchscreen display device 20 that allows the user to access the server system 12 to receive and store information within the server system 12 as well as interact with and operate the server system 12. In addition, in one embodiment, the system 10 may install an activity capture computer application program in the memory device of the mobile computing device 18 that includes a set of instructions for operating various features of the mobile computing device 18. When initiated by the processor of the mobile computing device 18, the mobile computer application program causes the processor of the mobile computing device 18 to execute an activity-capture sequence 34 (shown in FIGS. 9-19) for interacting with the server system 12. The activity-capture sequence 34 allows the user to operate the camera of the mobile computing device 18 to capture an image, assign additional information to the image, and transmit a data file including the image and user provided information to the server system 12.

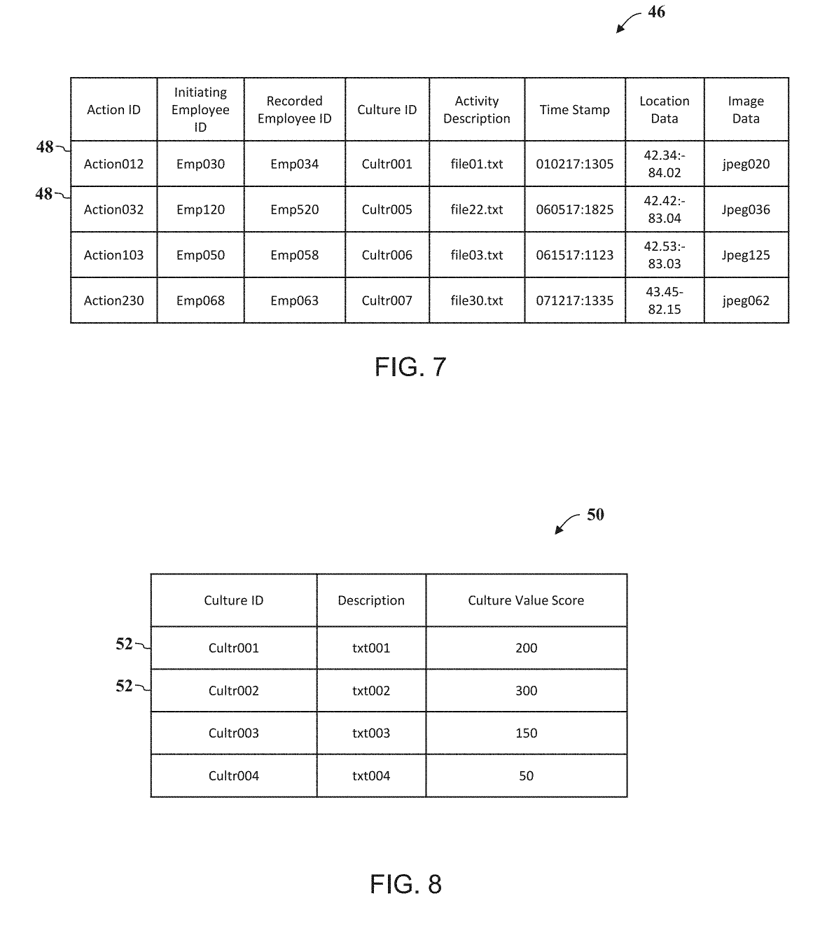

In the illustrated embodiment, the server system 12 includes a mobile application server 36, a website hosting server 38, a reporting server 40, a database server 42, and a database 44. In the illustrated embodiment, the server system 12 enables a user to initiate an activity-capture sequence 34 (shown in FIGS. 9-19) using the mobile computing device 18 to generate and store activity-capture data records (shown in FIG. 7). The activity-capture data records may be used by the server system 12 to generating various reports associated with employee activity including various indicators of employee satisfaction.

The database server 42 includes a memory device that is connected to the database 44 to retrieve and store information contained in the database 44. The database 44 contains information on a variety of matters, such as, for example, program files for use in generating web pages associated with one or more websites, employee account files, activity-capture data records, culture data files, mobile device identifies, mobile device application program interfaces (APIs), and/or any suitable information that enables the system 10 to function as described herein. In one embodiment, some or all of the information contained in the database 44 may also be stored in the database of the mobile computing device 18.

In the illustrated embodiment, the database 44 includes a capture data file 46 (shown in FIG. 7) that includes a plurality of activity-capture data records 48. Each activity-capture data record 48 includes information associated with an activity-capture sequence initiated by a user with the user computing device 14. For example, in one embodiment, the activity-capture data record 48 may include a unique activity ID for use in identifying and retrieving the activity-capture data record 48, an initiating employee ID associated with the employee initiating an activity capture sequence, a recorded employee ID associated with an employee included in the activity capture sequence, a culture ID associated with a culture data record, time-stamp data, location data indicating a location of the activity capture sequence, image data including information associated with a video and/or digital photographic image, and/or activity description data including textual information provided by the user initiating the activity-capture sequence.

The database 44 may also include a culture data file 50 that includes a plurality of culture data records 52 that includes information associated with one or more company culture indicators. Each culture data record 52 includes a unique culture ID, description data including information associated with a company culture indicator, and a culture value score including information indicating of the relative value of the corresponding company culture indicator.

The mobile application server 36 is configured to transmit and receive information from the mobile computing device 18 to initiate and execute the activity capture computer application program on the mobile computing device 18. For example, the mobile application server 36 may be configured to transmit and receives information from the mobile computing device 18 to enable the mobile computing device 18 to display activity-capture sequence webpages (shown in FIGS. 9-38) in response to receiving a user request that allows a user to initiate the activity-capture sequence to generate and store activity-capture data records 48 in the database 44.

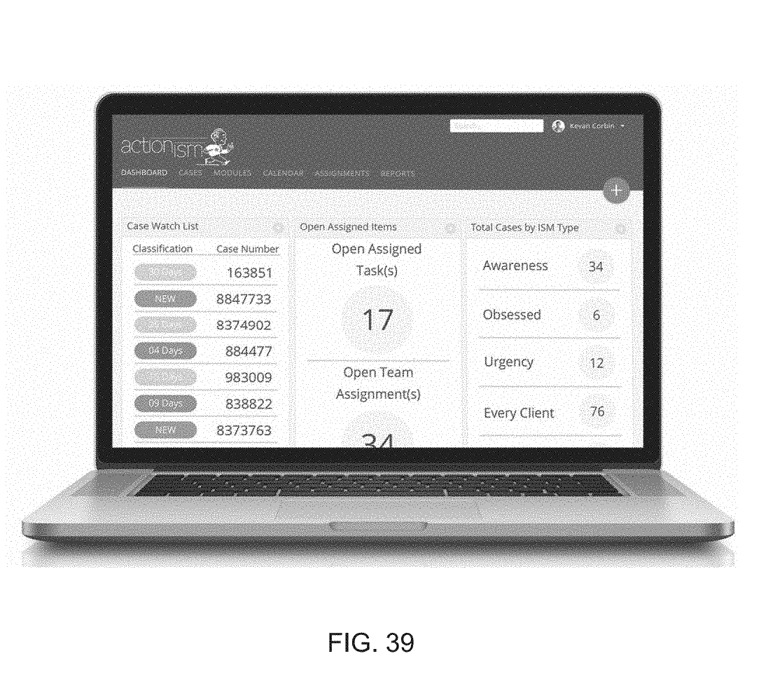

The website hosting server 38 is configured to host a website that is accessible by a user via one or more user computing devices 14. The website hosting server 38 retrieves and stores web pages (shown in FIGS. 39-41) associated with one or more websites in response to requests received by the user via the user computing device 14 to allow users to interact with the website. In one embodiment, the website hosting server 38 is configured to generate and display web pages including information being generated by the reporting server 40.

The reporting server 40 retrieves activity-capture data records 48 from the database and analyses the activity-capture data records 48 to generate a variety of company culture indicators that includes information associated with employee activity including various indicators of employee satisfaction. In one embodiment, the reporting server 40 is configured to generate various employee activity reports (shown in FIGS. 39-41) that may be displayed via one or more webpages.

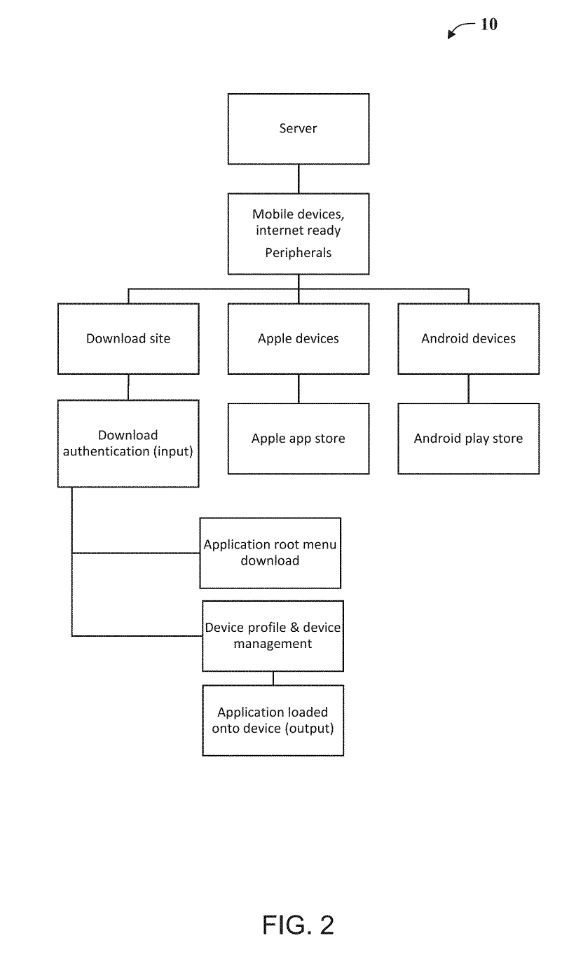

Referring to FIG. 2, in one embodiment, the system 10 may include a server computer 54 that is configured to perform the functions of the mobile application server 36, the website hosting server 38, the reporting server 40, and the database server 42. In the illustrated embodiment, the server computer 54 includes a processing device 56 and the database 44.

The processing device 56 executes various programs, and thereby controls components of the server computer 54 to user instructions received from the user computing device 14. The processing device 56 may include memory, e.g., read only memory (ROM) and random access memory (RAM), storing processor-executable instructions and one or more processors that execute the processor-executable instructions. In embodiments where the processing device 56 includes two or more processors, the processors can operate in a parallel or distributed manner. In an example, the processing device 56 may execute a communications module 58, a mobile application module 60, a website hosting module 62, and a reporting module 64.

The processing device 56 may also include a memory device for storing programs and information in the database 44, and retrieving information from the database 44 that is used by the processor to perform various functions described herein. The memory device may include, but is not limited to, a hard disc drive, an optical disc drive, and/or a flash memory drive. Further, the memory device may be distributed and located at multiple locations.

The communications module 58 retrieves various data and information from the database 44 and sends information to the user computing device 14 via the communications network 16 to enable the user to access and interact with the system 10. In one embodiment, the communications module 58 transmits data and instructions that causes the user computing device 14 to display various images on a graphical interface using data stored in the database 44.

The mobile application module 60 may be programmed to perform some or all of the functions of the mobile application server 36 including transmitting and receiving data from the mobile computing device 18 to enable the mobile computing device 18 to display the activity-capture sequence webpages (shown in FIGS. 9-38) to initiate the activity-capture sequence 34 to generate and store activity-capture data records 48 in the database 44.

The website hosting module 62 may be programmed to perform some or all of the functions of the website hosting server 38 including hosting various web pages associated with one or more websites that are stored in the database 44 and that are accessible to the user via the user computing device 14. The website hosting module 62 may be programmed to generate and display web pages associated with a website in response to requests being received from users via corresponding web browsers.

The reporting module 64 may be programmed to perform some or all of the functions of the reporting server 40 including generating and storing reporting data and information in response to various user requests.

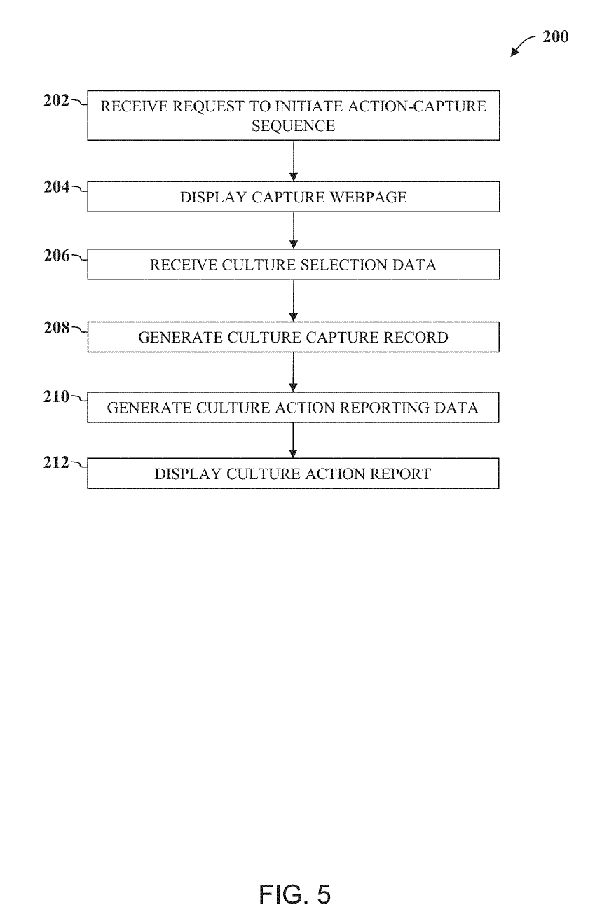

FIGS. 5 and 6 are flowcharts of methods 200 and 300 that may be used with the system 10 for implementing an activity-capture sequence for use in generating activity-capture records. The methods include a plurality of steps. Each method step may be performed independently of, or in combination with, other method steps. Portions of the methods may be performed by any one of, or any combination of, the components of the system 10. FIGS. 9-41 are exemplary graphical displays that may be displayed by the system 10.

In the illustrated embodiment, in method step 202, the mobile application server 36 receives a request to initiate an activity-capture sequence from a user via a mobile computing device 18. The response may include, for example, a signal from the mobile computing device 18 indicating the initiation of the activity-capture software application by the user on the mobile computing device 18.

In method step 204, in response to the request to initiate an activity-capture sequence, the mobile application server 36 transmits instructions to the mobile computing device 18 to cause the mobile computing device 18 to display activity capture webpages (shown in FIGS. 9-19) on the mobile computing device 18. The activity capture webpages prompts the user to enter a user identifier such as, for example, an email address or an employee ID.

In method step 206, upon receiving the user identifier, the mobile application server 36 causes the mobile computing device 18 to display a company culture selection page (shown in FIG. 12) that prompts the user to select one or more company culture indicators.

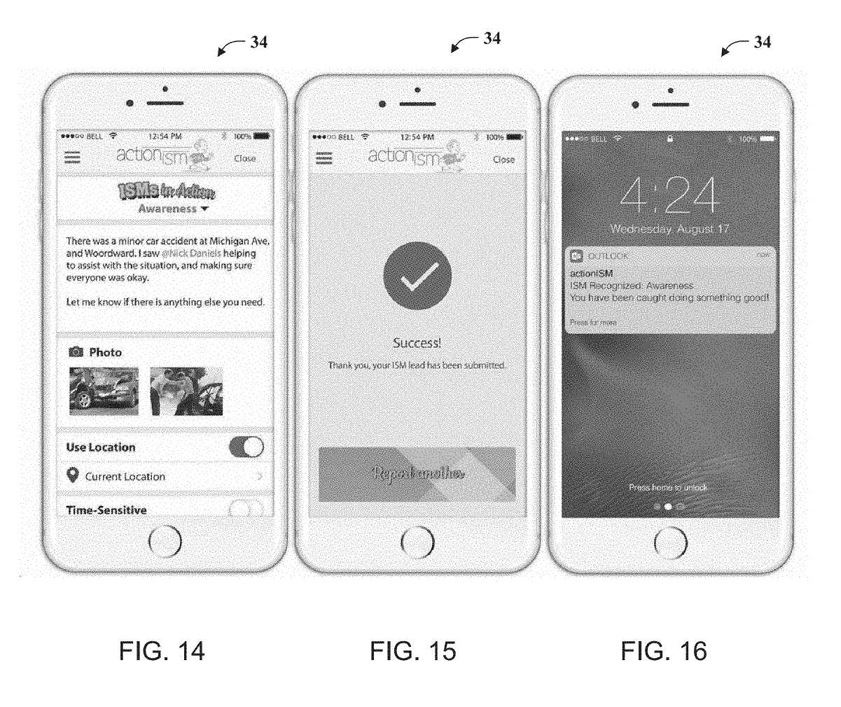

In method step 208, upon receiving a user selection of a culture indicator, the mobile application server 36 displays an activity capture screen (shown in FIG. 14) that allows the user operate the mobile computing device 18 to enter information associated with the selected culture indicator including operating the camera of the mobile computing device 18 to capture a digital photo image and/or video of an event, select an employee identifier associated with one or more employees included in the photo image and/or video, and a textual description of the captured activity. Upon receiving a request from the user, via the activity capture screen, the mobile computing device 18 transmit the captured information to the mobile application server 36. Upon receiving the captured information from the mobile computing device 18, the mobile application server 36 generates an activity-capture data record 48 including the information received from the mobile computing device 18 and stores the activity-capture data record in the database 44.

In method step 210, the reporting server 40 receives a request from a user to generate a culture activity report and access the database 44 to retrieve one or more activity-capture data records 48. For example, in one embodiment, the reporting server 40 may receive a request including an employee ID and retrieve each activity-capture data record 48 having a matching employee ID. The reporting server 40 may then analyze the retrieved activity-capture data records to generate various culture action reports.

In method step 212, the website hosting server 38 receives reporting data from the reporting server 40 and generates and displays a reporting webpage (shown in FIGS. 39-41) to display the various culture action reports via the reporting webpage.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

What is claimed is:

1. A networked computer system comprising:
a mobile computing device including a mobile computing device processor, a memory device, a touchscreen, and a camera, the memory device having an activity-capture software application program stored therein that, when executed, causes the mobile computing device processor to display a graphical user interface via the touchscreen; and;
a mobile application server computer including a processor programmed to:
receive a request to initiate an activity-capture sequence from a user via the mobile computing device, the request including a signal from the mobile computing device indicating an initiation of the activity-capture software application program by the user;
transmit instructions to the mobile computing device to cause the mobile computing device to display an activity capture webpage prompting the user to enter a user identifier;
upon receiving the user identifier, display a company culture selection webpage on the mobile computing device including one or more user selectable company culture indicators;
receive a user selection of a company culture indicator and display an activity capture screen that allows the user to operate the camera of the mobile computing device to capture a digital photo image of an event, select an employee ID associated with one or more employees included in the photo image, and input a textual description of the captured activity;
receive the captured information from the mobile computing device, generate an activity-capture data record including the information received from the mobile computing device, and store the activity-capture data record in a database;
receive a request from a user computing device to generate a culture activity report including an employee ID, access the database to retrieve one or more activity-capture data records having a matching employee ID, and analyze the retrieved activity-capture data records to generate various culture action reports; and
generate and display a reporting webpage on the user computing device to display the various culture action reports via the reporting webpage.

2. One or more non-transitory computer-readable storage media, having computer-executable instructions embodied thereon, wherein when executed by a processor, the computer-executable instructions cause the processor to:
receive a request to initiate an activity-capture sequence from a user via a mobile computing device, the request including a signal from the mobile computing device indicating an initiation of the activity-capture software application program by the user;
transmit instructions to the mobile computing device to cause the mobile computing device to display an activity capture webpage prompting the user to enter a user identifier;
upon receiving the user identifier, display a company culture selection webpage on the mobile computing device including one or more user selectable company culture indicators;
receive a user selection of a company culture indicator and display an activity capture screen that allows the user to operate a camera of the mobile computing device to capture a digital photo image of an event, select an employee ID associated with one or more employees included in the photo image, and input a textual description of the captured activity;
receive the captured information from the mobile computing device, generate an activity-capture data record including the information received from the mobile computing device, and store the activity-capture data record in a database;
receive a request from a user computing device to generate a culture activity report including an employee ID, access the database to retrieve one or more activity-capture data records having a matching employee ID, and analyze the retrieved activity-capture data records to generate various culture action reports; and
generate and display a reporting webpage on the user computing device to display the various culture action reports via the reporting webpage.
